(19) United States
(12) Patent Application Publication
(10) Pub. No.: US 2010/0213640 A1
(43) Pub. Date: Aug. 26, 2010

(54) MASONRY UNIT FORMING SYSTEMS AND METHODS

(75) Inventors: Mario Piazzesi, Naucalpan (MX); Douglas Stout, Danville, CA (US); Trevor Stout, Los Altos, CA (US); David Easton, Napa, CA (US)

Correspondence Address: MARGER JOHNSON & MCCOLLOM, P.C., 210 SW MORRISON STREET, SUITE 400, PORTLAND, OR, 97204, US

(73) Assignee: Integrity Block, Stockton, CA (US)

(21) Appl. No.: 12/393,951

(22) Filed: Feb. 26, 2009

(51) Int. Cl. B28B 3/08; B29C 43/00

(52) U.S. Cl. 264/333; 425/214; 425/355

(57) ABSTRACT

A masonry unit forming system including a mold box having a first open side and a second open side; a first mold plate; a second mold plate; a first drive mechanism configured to move the first mold plate into the first open side of the mold box; and a second drive mechanism configured to move the second mold plate into the second open side of the mold box.

### BACKGROUND

This disclosure relates to a masonry units and, in particular, masonry unit forming systems and methods.

Concrete masonry units (CMU) formed from cast concrete can be used in a variety of applications. For example, CMUs can be used in foundation walls, retaining walls, or the like. CMUs are produced in a variety of shapes and sizes for such applications. Industry-wide specifications, building codes, and the like define characteristics such as dimensional tolerances, densities, or the like for acceptable CMUs. Earthen materials can be used to form blocks of similar shapes. However, such blocks are typically weaker by an order of magnitude and cannot meet specifications established for CMUs.

### SUMMARY

An embodiment includes a masonry unit forming system including a mold box having a first open side and a second open side; a first mold plate; a second mold plate; a first drive mechanism configured to move the first mold plate into the first open side of the mold box; and a second drive mechanism configured to move the second mold plate into the second open side of the mold box.

Another embodiment includes a masonry unit forming system including a mold box; a first mold plate; a second mold plate; an impact driver configured to compress a material in the mold box between the first mold plate and the second mold plate.

Another embodiment includes a masonry unit forming system including a mold box; a first mold plate; a second mold plate; a first stop configured to limit a proximity of the first mold plate and the second mold plate in the mold box; and a second stop configured to limit travel of the second mold plate out of the mold box.

Another embodiment includes a masonry unit forming system including a mold box having a first cross-section; a first mold plate having a second cross-section substantially similar to the first cross-section; and a second mold plate having a third cross-section substantially similar to the first cross-section. The mold box has a volume greater than a finished volume of the masonry unit.

### BRIEF DESCRIPTION OF THE DRAWINGS

FIG. 1 is a block diagram of a mold box and mold plates of a masonry unit forming system according to an embodiment.

FIG. 2 is a block diagram of the mold box of FIG. 1 filled with an initial uncompressed volume of masonry material.

FIG. 3 is a block diagram of the mold box of FIG. 1 with the masonry material compressed to a final volume.

FIG. 4 is an isometric view of a mold box and inserts according to an embodiment.

FIG. 5 is an isometric view of a mold plate associated with the mold box of FIG. 4.

FIG. 6 is an isometric view of a mold box according to an embodiment.

FIG. 7 is an isometric view of a second mold plate and inserts associated with the mold box of FIG. 6.

FIG. 8 is an isometric view of a first mold plate associated with the mold box of FIG. 6.

FIG. 9 is a side elevation view illustrating stops in a masonry unit forming system according to an embodiment.

FIG. 10 is a side elevation view of the masonry unit forming system of FIG. 6 with mold plates limited by a stop in a different position.

FIG. 11 is a side elevation view of a masonry unit forming system according to an embodiment.

FIG. 12 is flowchart illustrating a technique of forming a masonry unit according to an embodiment.

FIG. 13 is a plan view of hand for transporting a masonry unit according to an embodiment.

FIG. 14 is an isometric view illustrating forces applied to a masonry unit by the hand of FIG. 13 according to an embodiment.

### DETAILED DESCRIPTION

Embodiments will be described in reference to the drawings. In particular, embodiments will be described where masonry units and, in particular, earthen masonry units can be formed.

As used herein, a masonry unit is a shape formed from earth, concrete, aggregate, cement, or the like. For example, a concrete masonry unit (CMU) is substantially formed from cement and an aggregate. In another example, an earthen masonry unit can have similar materials, but can include soil, minerals, alternative binders, or the like.

Masonry units have a variety of common shapes. For example, shapes of masonry units can include standard hollow blocks, pilaster blocks, landscape blocks, or the like. Such blocks, in particular such blocks used in load bearing construction, can be associated with a particular standard. For example ASTM International publishes standards for masonry units such as ASTM C90. Such standards can define load bearing characteristics, dimensions, or the like for masonry units.

As described above, masonry units can include earthen materials that are not found in traditional a traditional CMU. However, masonry units can be formed from such materials and meet specified standards. In one particular aspect, a particular density a masonry unit may be selected to achieve such characteristics. However, a density of the masonry material may be substantially less than that of the desired density. Accordingly, in an embodiment, the manufacture of a masonry unit with such materials can take into account such a difference in density. As a result, a consistent masonry unit that is compliant with specified standards can be formed from earthen or alternative materials.

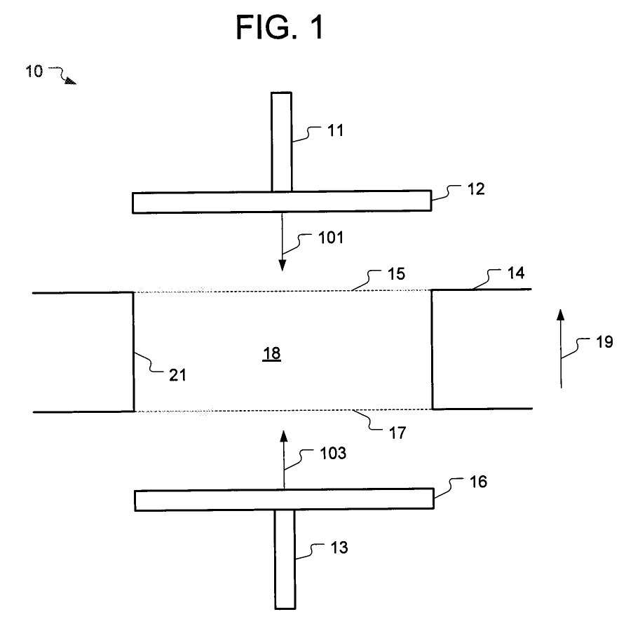

FIG. 1 is a block diagram of a mold box and mold plates of a masonry unit forming system according to an embodiment. In this embodiment, the masonry unit forming system 10 includes a mold box 14, a first mold plate 12, a second mold plate 16, a first drive mechanism 11, and a second drive mechanism 13. The mold box 14 can include vertical sidewalls 21 defining a lateral periphery of the open region 18.

A mold box 14 is a receptacle suitable for receiving masonry material. Although the term box has been used, the mold box 14 can but need not include planar sides disposed orthogonally. For example, the mold box can have curved sides, irregular sides, or the like. In an embodiment, the mold box can be a cylinder. As used herein, as cylinder is a generic cylinder and is not limited to a cylinder with a circular or elliptical cross-section. A cylinder can have any cross-sectional shape where that cross-sectional shape is extended along an axis of the cylinder. As will be described in further detail below, the mold box can have a contour corresponding to an outline of a masonry unit.

Regardless of the shape, the mold box 14 includes an open region 18. In an embodiment, the mold box includes two open sides 15 and 17 exposing the open region 18. Each of the mold plates 12 and 16 is configured to enter the open region 18 of the mold box 14.

As used herein a mold plate is a structure having a surface that will contact masonry material within the mold box 14. The mold plate can have a variety of shapes, as will be further described below, depending on the shape of the finished masonry unit.

The first drive mechanism 11 is configured to move the first mold plate 12 into the first open side 15 of the mold box 14 in direction 101. The second drive mechanism 13 configured to move the second mold plate 16 into the second open side 17 of the mold box 14 in direction 103. In this embodiment, the directions 101 and 103 are substantially parallel, although opposite in direction. The first and second drive mechanisms 11 and 13 can be a variety of mechanisms. For example, such drive mechanisms can include linear actuators, pneumatic cylinders, hydraulic cylinders, mechanical linkages, geared mechanisms, impact vibrators, or the like.

In an embodiment, the first drive mechanism 11 and the second drive mechanism 13 can be separate. Accordingly, the drive mechanisms 11 and 13 can be actuated independently. For example, the first drive mechanism 11 can be a pneumatic cylinder while the second drive mechanism 13 is a geared mechanical linkage.

In another embodiment, the first drive mechanism 11 and the second drive mechanism 13 can include a common drive mechanism. For example, the first drive mechanism 11 and the second drive mechanism 13 can be coupled by mechanical linkages. A single power source, such as a pneumatic cylinder, can apply a force directly to the first mold plate 12 while the mechanical linkages apply the force to the second mold plate 16.

Regardless of the particular implementation of the first and second drive mechanisms 11 and 13, force can be directly applied to masonry material within the mold box 14 by both the first mold plate 12 and the second mold plate 16. As a result, a masonry unit can be formed in the mold box 14 through compaction from both sides.

In an embodiment, one or more of the first and second drive mechanisms 11 and 13 can include an impact driver. As used herein, an impact driver is a device that can supply mechanical impulses in contrast to a substantially consistent force. The impact driver is configured to compress a material in the mold box between the first mold plate and the second mold plate. That is, the compression of the masonry material occurs at least in part due to impulses rather than a constant pressure.

The impact driver can include a variety of devices. For example, the impact driver can include a pneumatic impact vibrator, a hydraulic impact hammer, an electro-mechanical vibrator, or the like. Any device that can supply an impulse can be used as an impact driver.

In an embodiment, the impact driver can be configured to supply an impulse in a direction aligned along an axis of the mold box 14. For example, an impact driver can be configured to supply an impulse along axis 19. That is, the impulse can be applied along a direction of movement 101 and 103, for example, of the mold plates 12 and 16 through the mold box 14.

Similar to the first and second drive mechanisms 11 and 13 described above, the impact driver can be a single driver or multiple drivers. For example as will be described in further detail below, the impact driver can be coupled to the first and second drive mechanisms 11 and 13 such that the impulses are propagated through the first and second drive mechanisms 11 and 13 to apply the impulses to the masonry material. In another embodiment, the impact driver can be divided into two impact drivers such that impulses can be applied to each of the mold plates 12 and 16 independently or in concert.

In an embodiment, a masonry unit forming system can accommodate a variable composition of the masonry material, yet still achieve a consistent product. For example, to achieve a particular density of a finished masonry unit, a sufficient amount of material having a weight substantially equivalent to the finished masonry unit can be supplied to the mold box 14. However, since such masonry material can be less dense than the finished density, the supplied volume can be larger than the finished volume of the masonry unit.

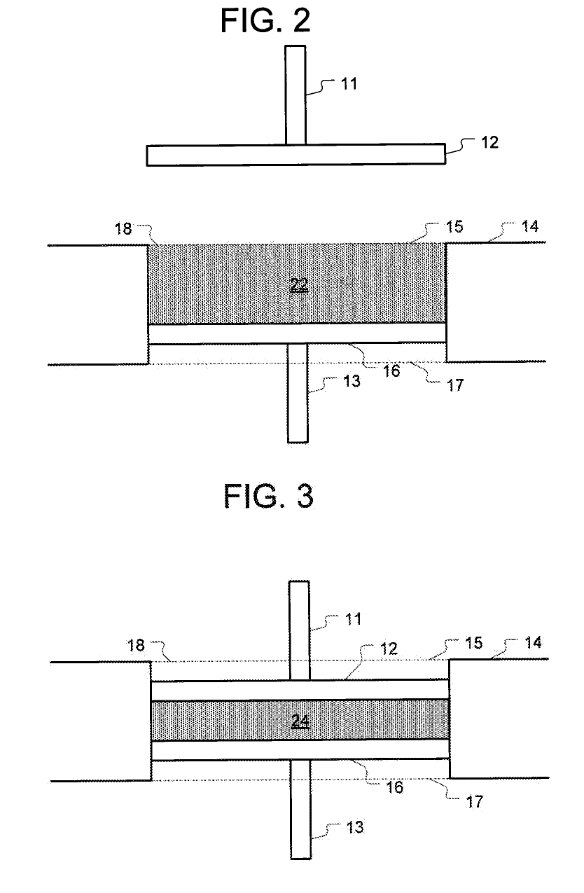

FIG. 2 is a block diagram of the mold box of FIG. 1 filled with an initial uncompressed volume of masonry material. In this embodiment, an initial volume 22 of masonry material has been provided to the mold box 14. The second drive mechanism 13 can be configured to position the second mold plate 16 within the mold box 14 such that the initial volume 22 of the mold box is substantially equal to an initial mix volume of the masonry unit. The initial mix volume can be the volume of the masonry material which has a weight substantially equivalent to a desired weight of a finished masonry unit. Although in this embodiment, the initial volume 22 is illustrated as bounded by the open side 15, the initial volume can include other boundaries both inside the mold box 14, outside the mold box 14, or the like.

As the second mold plate 16 can be positioned within the mold box 14, the initial volume 22 can be varied. Accordingly, the initial volume 22 can be controlled according to the incoming masonry material. For example, if a masonry material with a smaller density is used, the initial volume 22 can be larger, and vice versa. That is, even for the same finished shape of a masonry unit, the initial volume 22 can be varied to accommodate variations in the masonry material.

FIG. 3 is a block diagram of the mold box of FIG. 1 with the masonry material compressed to a final volume 24. First mold plate 12 is illustrated as compressing the masonry material with the second mold plate 16. In particular, the volume 24 of the compressed masonry material is less than the initial volume 22. In an embodiment, the volume 24 can be substantially the same as the volume of a finished masonry unit.

As used herein, a finished masonry unit is a masonry unit that is finished at the particular point in processing. For example, although he masonry unit formed as described with respect to FIG. 3 has been described as finished, the masonry unit may receive further processing, curing, or the like. As a result, the masonry unit may change volume, dimensions, or the like before the appropriate time to evaluate the masonry unit according to a given standard. Thus, a finished masonry unit at a particular point is a masonry unit that substantially has the characteristics such that when subsequent processing, if any, is performed, the masonry unit can comply with a particular standard. However, even though a finished masonry unit has been described with reference to a standard, no standard is necessary. Finished can refer to the end of a stage of the molding process.

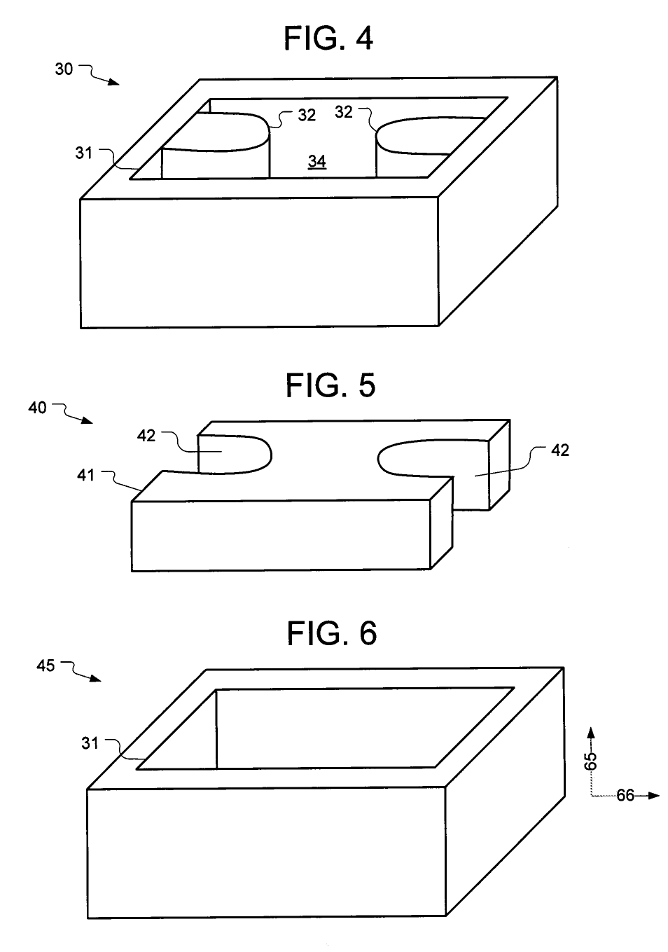

FIG. 4 is an isometric view of a mold box and inserts according to an embodiment. As described above, a mold box can have a cylindrical cross-section. In this embodiment, the mold box 30 includes a rectangular cross-section with an outer perimeter 31 defining a general shape of a masonry unit. However, masonry units with similar shapes can have a variety of differences. For example, a hollow block can have openings within the block yet the outer perimeter matches the outer perimeter 31. An open-ended bond beam block can have a similar outer perimeter 31, yet the openings can extend to the perimeter 31.

In this embodiment, the mold box 30 is for such an open-ended bond beam block. Inserts 32 within the mold box 30 result in the openings of a finished masonry unit. A result of the arrangements of the inserts 32 within the mold box 30, an opening 34 is created having a cross-section substantially the same as a desired masonry unit.

In an embodiment, the mold box 30 along with any inserts can have an intrinsic volume that is greater than the first volume described above. The insertion of the mold plate reduces the intrinsic volume to the first volume. As the same mold box can be used for different mixes of masonry material, different inserts can be used to for differently shaped blocks, or the like. For example, a mold plate can have flutes to create a void in a masonry unit such as in a bond-beam block. The initial volume of masonry material for such blocks can vary. In another example, blocks with different heights, but the same lengths and widths can be formed using the same mold box. The mold box can be large enough to accommodate the variety of different initial volumes.

FIG. 5 is an isometric view of a mold plate associated with the mold box of FIG. 4. The mold plate 40 has an outer perimeter 41 that is similar to the outer perimeter 31 of the mold box 30. The openings 42 in the mold plate 40 are similar to the inserts 32 of the mold box 30. Accordingly, the mold plate 44 has a cross-section that is substantially the same as an open area 34 of the mold box 30. As a result, the mold plate 40 can be inserted into the mold box 30. Moreover, the mold plate 40 can travel along a length of the mold box 30. As a result, the mold plate 40 can be moved to a variety of positions within the mold box 34.

FIG. 6 is an isometric view of a mold box according to another embodiment. In contrast to the mold box of FIG. 4, in this embodiment, the mold box 45 does not include inserts 32. For illustration, the mold box 45 has the same outer perimeter 31 as mold box 30. This illustrates the configurability of the mold box. For example, to change from an open-ended bond beam block as described above with respect to FIGS. 4 and 5, to a standard hollow block, the same mold box can be used by removing the inserts 32.

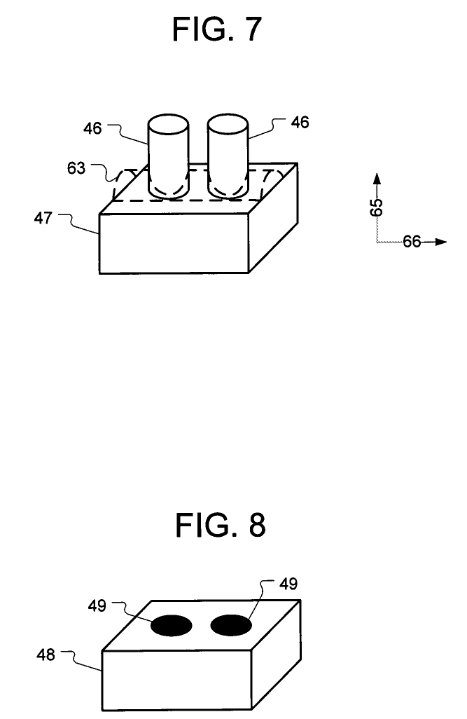

FIG. 7 is an isometric view of a second mold plate and inserts associated with the mold box of FIG. 6. The mold plate 47 has openings in which inserts 46 can be placed. Although the mold plate 47 and the inserts 46 have been illustrated together, the mold plate 47 and inserts 46 can be discrete components. For example, the mold plate 47 and inserts 46 can be commonly attached to a lower plate. Alternatively, the mold plate 47 and inserts 46 can be a contiguous structure.

FIG. 8 is an isometric view of a first mold plate associated with the mold box of FIG. 6. The first mold plate 48 includes openings 49. The openings 49 correspond to the inserts 46 of FIG. 7. Accordingly, the second mold plate 47 can be inserted into one side of the mold box 45 of FIG. 6. The first mold plate 48 can be inserted into another side of the mold box 45. As the mold plates 47 and 48 are compressed together, the masonry material can be compressed into the final volume. Since the openings 49 can allow the inserts 46 to pass before and during compression of the masonry material, masonry material will not pass into the openings 49.

Although mold plates have been illustrated with substantially planar surfaces, mold plates can have non-planar surfaces. For example, a mold plate standard hollow block such as the mold plates illustrated in FIGS. 7 and 8 can have planar surfaces. However, a bond beam block can be formed using a mold plate that includes surfaces that correspond to the void in a bond beam block beyond those in a standard hollow block. Accordingly, the mold plate can have flutes that create such a structure. Such flutes can be integral with the mold plate, detachable, or the like.

For example, referring to FIGS. 7 and 8, the second mold plate 47 can include a flute 63. As used herein, a flute 63 is an insert that extends along a direction different from a direction of insertion of the mold plate 47 into a corresponding mold box. That is, in this embodiment, the mold plate 47 can be inserted in the opening of the mold box 45 along direction 65. Inserts 46 can similarly extend along direction 65. However, the flute 63 extends along direction 66 in this embodiment. Furthermore, although the flute 63 has been illustrated as separate from the mold plate 47, the flute can be integral with the mold plate 47.

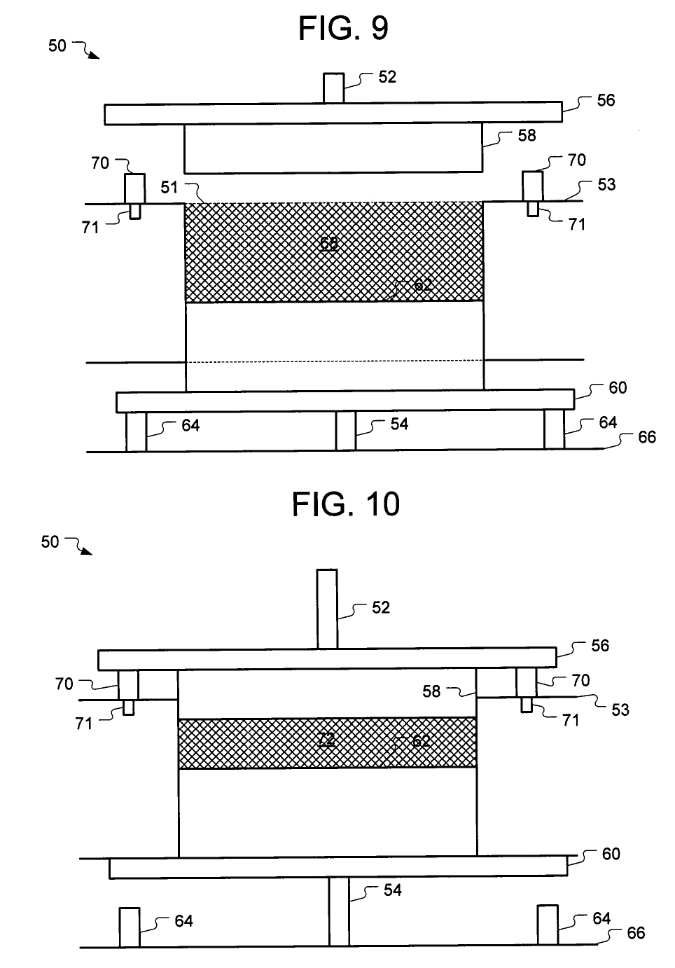

FIG. 9 is a side elevation view illustrating stops in a masonry unit forming system according to an embodiment. In this embodiment, the masonry unit forming system 50 includes a mold box 53, a first mold plate 58, and a second mold plate 62. A first stop is configured to limit proximity of the first mold plate and the second mold plate within the mold box. In this embodiment, the first stop includes stops 70.

The system 50 also includes a second stop configured to limit travel of the second mold plate out of the mold box. The second stop includes stops 64. The second drive mechanism 54 is configured to position the second mold plate in the mold box 53. In this embodiment, the second mold plate 62 is mounted on a lower plate 60. As the second mold plate 62 and the lower plate 62 are removed from the mold box 53, the lower plate 60 contacts the stops 64, limiting the movement.

As a result, the movement of the second mold plate 62 out of the mold box 53 is limited. A volume 68 bounded by the mold box 53, the second mold plate 62 and the upper surface 51 of the mold box 53. As described above, this volume 68 can be an initial volume of masonry material for a masonry unit. Since the stops 64 define a low point of the second mold plate in the mold box 53, the stops 64 define the initial volume. Accordingly, the stops 64 can be changed, adjusted, or the like to change the initial volume 68. As a result, the same mold box 53, mold plates 58 and 62 can be used with a variety of mixes of masonry materials. In particular, a variety of densities of masonry materials can be used with the same mold box 53, mold plates 58 and 62.

FIG. 10 is a side elevation view of the masonry unit forming system of FIG. 9 with mold plates limited by a stop in a different position. In particular, the proximity of the mold plates 58 and 62 is limited by stops 70. In particular, mold plate 58 is mounted on top plate 12. As the first mold plate 58 and the second mold plate 62 approach each other, compressing the masonry material in volume 72, top plate 56 contacts stops 70, limiting the movement of first mold plate 58 into the mold.

In this embodiment, the movement of the second mold plate 62 into the mold box 53 is limited by the contact of the lower plate 60 and the mold box 53. As a result, due to the stops 70 and the mold box 53, the volume 72 of the masonry material compressed within the mold can have controlled dimensions. That is, the mold box 53 and the mold plates 58 and 62 create defined dimensions.

As described above, the initial masonry material may have a greater volume than the finished volume of the masonry unit. A ratio of the finished volume to the initial volume can be 50%, 90% or the like. Depending on the mix of the masonry material, the ratio can vary. By using the stops 64, 70, and the like, a variable initial volume of material can be used to create a finished masonry unit with the defined dimensions.

The stops 64 and 70 can take a variety of forms. For example, the stops can be cylinders having fixed sizes. The stops can be exchanged to change the respective initial volume or final volume. In another example, the stops can be adjustable. The stops can include threaded mounting points so that the associated distances can be continuously adjusted. As used herein, adjustable includes adjustable in place and adjustable through substitution. For example, such threaded structures can be adjustable in place. In another example, the stops 70 each include a pin 71 to secure the stop in the mold box 53.

In another embodiment, the stops need not be physical structures. For example, the stops can be implemented in control circuitry for the drive mechanisms 52 and/or 54. Moreover, such stops can be mixed within a single system. For example, stops associated with the bottom plate 60 may be electrically controlled through the drive mechanism 54 while the stops associated with the top plate 56 can be physical structures.

Furthermore, the stops can, but need not be limited to a single location. For example the stops 70 can include structures that limit the proximity of both the top plate 56 and the bottom plate 60 to the mold box 53. Such structures can be located on both the top plate 56 and the bottom plate 60. In another example, stops can be placed on columns on which the top plate 56 or the bottom plate 60 travel or to which the plates 56 or 60 are coupled.

Moreover, the stops 64 and 70 can be movable. That is, the stops 64 and 70 can be configured to be in position when needed. For example, the stops 70 can be moved out of the way while masonry material is loaded into the mold box 53. Afterwards, the stops 70 can be returned to the respective positions.

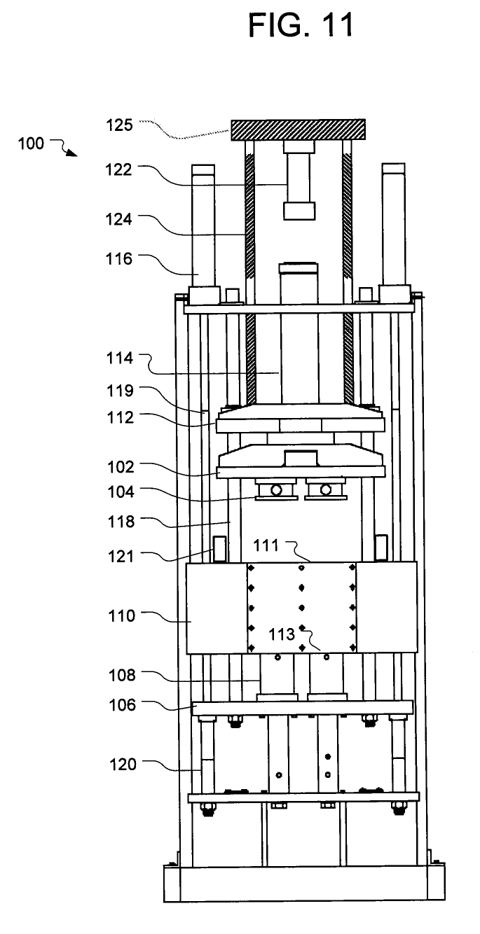

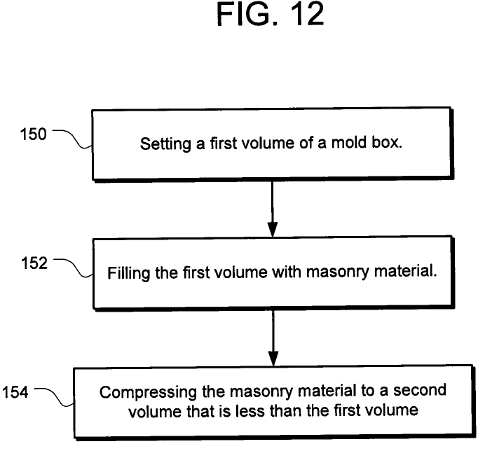

FIG. 11 is a side elevation view of a masonry unit forming system according to an embodiment. In this embodiment the masonry unit forming system 100 includes a mold box 110. The mold box 110 includes open sides 111 and 113. A first mold plate 104 is mounted on a top plate 102. The top plate 102 is coupled to a piston of pneumatic cylinder 114. A housing of the pneumatic cylinder 114 is mounted to a mounting plate 112. The mounting plate 112 mounted to columns 118. Columns 118 extend through the mold box 110 to a bottom plate 106. A second mold plate 108 is mounted on the bottom plate 106.

The mounting plate 112 and the bottom plate 106 have a fixed relationship due to the respective mounting on the columns 118. Columns 119 are mounted to the bottom plate 106. The columns 118 are coupled to pneumatic cylinders 116.

When the pneumatic cylinders 116 are actuated, the bottom plate 106 can be moved towards the mold box 110. Movement of the bottom plate 106 away from the mold box 110 by the pneumatic cylinders 116 is limited by stops 120. Accordingly, the movement of the second mold plate 108 out of the mold box 110 is limited, creating a volume within the mold box 110. As described above, this volume can be the initial volume. As the stops 120 and the mold box 110 are mounted to the frame 101, the stops 120 and the mold box 110 have a fixed relationship. When the bottom plate 106 contacts the stops 120, a surface of the mold plate 108 within the mold box 110 will have a fixed relationship to the mold box 110.

As described above, the bottom plate 106 and the mounting plate 112 have a fixed relationship. Thus, when the pneumatic cylinder 114 is actuated, the top plate 104 moves towards the mold box 110. With further actuation, the first mold plate 104 will contact masonry material within the mold box 110. At this point, the force applied by the pneumatic cylinder 114 will be divided between the first mold plate 104 and the second mold plate 108. That is, the contact of the masonry material and the first mold plate 104 will exert a force against the first mold plate 104 which is propagated back to the second mold plate 108. Thus, the masonry material within the mold box 110 will be compressed from both sides.

While the masonry material in the mold box 110 is being compressed, a distance between the top plate 102 and the bottom plate 106 will be reduced. Eventually, the top plate 102 will contact the stops 121 and the bottom plate 106 will contact the mold box 110. The contacts can occur in any order. Once contact is made by both the top plate 102 and the bottom plate 106, the movement between the top plate 102 and the bottom plate 106 will be limited, defining the associated dimension of the masonry unit formed in the mold box 110.

During the actuation of the pneumatic cylinder 114, the pneumatic impact vibrator 122 can be actuated. The pneumatic impact vibrator 122 is coupled by columns 124 and header 125 to the mounting plate 112. Accordingly, impulses generated by the pneumatic impact vibrator 122 can be transferred to the first mold plate 104 and the second mold plate 108 through the corresponding mechanical linkages. Thus, impulses can be used in the compression of the masonry material in the mold box 110, and in particular, impulses can be applied to both sides of the masonry material.

FIG. 12 is flowchart illustrating a technique of forming a masonry unit according to an embodiment. In 150, a volume of a mold box is set to a first volume. For example, as described above, a mold plate can be positioned in the mold box, reducing a total volume in the mold box such that a remaining volume is an initial volume associated with a particular masonry material and final volume.

Part of setting the first volume can include changing the first volume according to a density of the masonry material. As described above, different density materials can result in different initial volumes for the same finished masonry unit. Changing the first volume can include changing stops as described above, adjusting the stops, changing the position of the mold plate bounding the first volume, or the like.

Regardless of how the first volume is formed, the first volume of the mold box is filled with masonry material in 152. In an embodiment, the mold box can be overfilled with masonry material and the excess can be removed with a wiper. In another embodiment, the masonry material delivery structure can level the masonry material in the mold box.

As described above, the bounds of the first volume can be defined by the mold box, a mold plate, and a surface of the mold box. With the mold plate in position in the mold box, the removal of the excess material, and in particular, the removal of the excess material beyond the surface of the mold box causes the remaining masonry material to be substantially equal to the first volume.

Although a particular sequence has been described above, the setting of the first volume and the filling with the masonry material can occur in different orders. For example, the mold box can be filled with masonry material. The mold plate can then be positioned in the mold box to expel any excess masonry material.

Regardless, a first volume of masonry material is present in the mold box. The masonry material can then be compressed to a second volume that is less than the first volume in 154. In an embodiment, another mold plate in addition to the mold plate forming the first volume can be applied to the masonry material. The second volume can be substantially equal to a volume of a finished masonry unit.

In an embodiment, the compression can be performed using force applied from two sides. For example, as described above, mechanical linkages can cause the force to be applied to the mold plates within the mold box. Moreover, as described above, the compression applied can include a series of impulses.

In an embodiment the mold plate can be extended through the mold box. In another embodiment, the mold plate can be lowered out of the mold box. As a result, the masonry unit can be removed from the mold box.

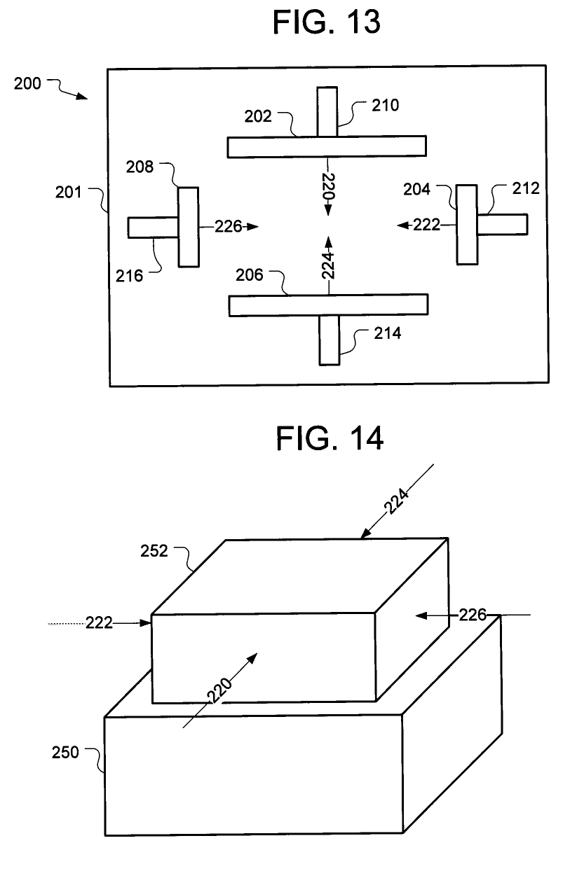

FIG. 13 is a plan view of hand for transporting a masonry unit according to an embodiment. Masonry units can be fragile after creation. In addition, some masonry units can have voids created by inserts as described above. For example, a bond beam block can be created by adding a flute, as described above. The masonry unit must be removed from the inserts.

In an embodiment, an arm can be used to lift the finished masonry unit using the hand of FIG. 13. In particular, the hand 200 includes a housing 201, and plates 202, 204, 206, and 208. The plates 202, 204, 206, and 208 include corresponding drive mechanisms 210, 212, 214, and 216, respectively. The drive mechanisms 210, 212, 214, and 216 are configured to move the corresponding plates along corresponding directions 220, 222, 224, and 226. The drive mechanisms can be any of the variety of drive mechanisms described above.

When actuated, the drive mechanisms 210, 212, 214, and 216 are configured to move the corresponding plates 202, 204, 206, and 208 to be in contact with a masonry unit. For example, the arm can position the hand around the masonry unit. The drive mechanisms 210, 212, 214, and 216 can control the movement of the corresponding plates 202, 204, 206, and 208 such a substantially similar amount of force is applied by each of the plates 202, 204, 206, and 208.

FIG. 14 is an isometric view illustrating forces applied to a masonry unit by the hand of FIG. 13 according to an embodiment. Referring to FIGS. 13 and 14, an unloading of a masonry unit 252 will be described. The masonry unit 252 has been extracted from the mold box 250. For example, as described above, a mold plate can be extended through the mold box to extract the masonry unit 252 from the mold box 250. However, the masonry unit 252 can be extracted from the mold box 250 in other ways, for example, by moving the mold box 250.

Regardless of how the masonry unit 252 is extracted, the hand 200 of FIG. 13 can be placed around the masonry unit 252. Directions 220, 222, 224, and 226 are illustrated relative to the masonry unit 252. Thus, the hand 200 can apply pressure to the masonry unit 252 along directions 220, 222, 224, and 226. That is, the masonry unit 252 can be grasped by applying pressure to the sides of the masonry unit 252. The masonry unit 252 can then be unloaded. In particular, if a flute or other insert, as described above, has been used in the formation of the masonry unit 252, the masonry unit 252 can be lifted off of the flute in the process of unloading.

Although particular embodiments have been described, it will be appreciated that the principles of the invention are not limited to those embodiments. Variations and modifications may be made without departing from the principles of the invention as set forth in the following claims.

What is claimed is:

1. A masonry unit forming system, comprising:
a mold box having a first open side and a second open side;
a first mold plate;
a second mold plate;
a first drive mechanism configured to move the first mold plate into the first open side of the mold box; and
a second drive mechanism configured to move the second mold plate into the second open side of the mold box.

2. The masonry unit forming system of claim 1, wherein the mold box has a cylindrical shape.

3. The masonry unit forming system of claim 1, wherein the first drive mechanism includes a first stop limiting movement of the first mold plate into the mold box.

4. The masonry unit forming system of claim 3, wherein the second drive mechanism includes a second stop limiting movement of the second mold plate out of the mold box.

5. The masonry unit forming system of claim 4, wherein:
the second drive mechanism is configured to position the second mold plate within the mold box such that a remaining volume of the mold box is substantially equal to an initial volume of the masonry material when limited by the second stop; and
when the first drive mechanism is substantially at the first stop, the remaining volume of the mold box is a finished volume; and
the initial volume is less than the finished volume.

6. The masonry unit forming system of claim 1, wherein at least one of the first drive mechanism and the second drive mechanism includes an impact driver.

7. The masonry unit forming system of claim 1, wherein the first mold plate and the second mold plate each have a cross-sectional shape substantially similar to a cross-sectional shape of the mold box.

8. A masonry unit forming system, comprising:
a mold box;
a first mold plate;
a second mold plate;
an impact driver configured to compress a material in the mold box between the first mold plate and the second mold plate.

9. The masonry unit forming system of claim 8, further comprising:
a linear actuator including a housing and a column; and
a top plate fixed to the housing of the linear actuator;
wherein:
the impact driver is fixed to the top plate; and
the first mold plate is fixed to the column of the linear actuator.

10. The masonry unit forming system of claim 9, wherein:
the linear actuator is a pneumatic cylinder; and
the impact driver is pneumatic impact vibrator.

11. A masonry unit forming system, comprising:
a mold box;
a first mold plate;
a second mold plate;
a first stop configured to limit a proximity of the first mold plate and the second mold plate in the mold box; and
a second stop configured to limit travel of the second mold plate out of the mold box.

12. The masonry unit forming system of claim 11, wherein:
a first volume bounded by the second mold plate and the mold box is formed when the second mold plate is limited by the second stop;
the first volume corresponds to an initial volume of masonry material for a finished masonry unit having a finished volume; and
the finished volume is less than the initial volume.

13. The masonry unit forming system of claim 12, wherein a ratio of the finished volume to the initial volume is less than 90%.

14. The masonry unit forming system of claim 11, wherein:
the second mold plate has as first position in the mold box when the second mold plate is limited by the second stop;
the second mold plate has a second position in the mold box when the proximity of the first mold plate and the second mold plate is limited by the first stop; and
the first position is different from the second position.

15. A masonry unit forming system, comprising:
a mold box having a first cross-section;
a first mold plate having a second cross-section substantially similar to the first cross-section and configured to be movable within the mold box; and
a second mold plate having a third cross-section substantially similar to the first cross-section and configured to be movable within the mold box;
wherein the mold box has a volume greater than a finished volume of the masonry unit.

16. The masonry unit forming system of claim 15, wherein:
the mold box includes at least one insert extending through an opening of the mold box; and
each of the first mold plate and the second mold plate include at least one opening corresponding to the at least one insert of the mold box.

17. The masonry unit forming system of claim 15, further comprising:
at least one insert disposed to be within the first cross-section of the mold box when forming the masonry unit;
wherein each mold plate includes at least one opening corresponding to the at least one insert.

18. The masonry unit forming system of claim 15, further comprising:
a hand including:
a plurality of plates; and
a plurality of drive mechanisms, each drive mechanism configured to actuate a corresponding one of the plates;
an arm configured to position the hand over a masonry unit;
wherein the drive mechanisms are configured to apply a substantially similar pressure on the masonry unit by each plate.

19. A method of forming a masonry unit, comprising:
setting a first volume of a mold box by positioning a mold plate within the mold box to reduce a volume of the mold box to the first volume;
filling the first volume of the mold box with masonry material; and
compressing the masonry material in the mold box to a second volume;
wherein the second volume is less than the first volume.

20. The method of claim 19, wherein the second volume is substantially equal to a volume of a finished masonry unit.

21. The method of claim 19, further comprising extending the mold plate through the mold box.

22. The method of claim 19, wherein compressing the masonry material comprises:
positioning a mold plate over the masonry material; and
impacting the masonry material with the mold plate until the masonry material is compressed to the second volume.
